(19) United States
(12) Patent Application Publication
(10) Pub. No.: US 2006/0136602 A1
(43) Pub. Date: Jun. 22, 2006

(54) Electronic data interchange apparatus

(75) Inventors: Toru Araki, Kawasaki (JP); Takeo Yasukawa, Kawasaki (JP); Katsutoshi Ito, Kawasaki (JP); Yoshihide Nomura, Kawasaki (JP); Tsuyoshi Kanai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/120,965

(22) Filed: May 4, 2005

(30) Foreign Application Priority Data
Nov. 26, 2004 (JP) 2004-342805

(51) Int. Cl. G06F 15/16

(52) U.S. Cl. 709/246

(57) ABSTRACT

A determining unit determines processing for converting data, by referring to (A) use condition information in which data transmission methods and data format of senders and receivers are registered, (B) reception template information, in which the configuration of the processing is registered, and (C) transmission template information 231c. An executing unit executes the determined processing, to realize data conversion and transmission.

### BACKGROUND OF THE INVENTION

1) Field of the Invention

The present invention relates to an electronic data interchange apparatus that performs format conversion and protocol conversion between a sender and a receiver.

2) Description of the Related Art

Conventionally, electronic data interchange systems for business transaction via a communication line have been widely used. The electronic data interchange systems are very useful for performing transactions promptly. However, since the data formats and transmission methods are different among users, there is a disadvantage that, as the number of users to be dealt with increases, the system becomes more complicated.

In order to improve this disadvantage, Japanese Patent Application Laid-open No. 2001-283040 discloses a technique in which transaction data is converted to a predetermined common data format, thereby simplifying the structure of the electronic data interchange system. Japanese Patent Application Laid-open No. 2002-342593 also discloses a technique in which a conversion rule is registered for each combination of a sender and a receiver, and data conversion and transmission are performed based on the conversion rule.

However, the conventional art disclosed in Japanese Patent Application Laid-open No. 2001-283040 has a problem that the system must be changed considerably when it becomes necessary to add a new item, which is not initially assumed, in the common data format. On the other hand, the conventional art disclosed in Japanese Patent Application Laid-open No. 2002-342593 has a problem that, as the number of users increases, much time and labor are required for registration and management of the conversion rule which is to be registered for each combination of a sender and a receiver.

### SUMMARY OF THE INVENTION

It is an object of the present invention to at least solve the problems in the conventional technology.

An electronic data interchange apparatus according to an aspect of the present invention includes a determining unit that determines each piece of processing that forms a series of processing to be executed for the data based on at least a transmission method and a data format that are specified by any one of the sender and the receiver or both; a selecting unit that selects a module for each piece of processing determined from among a plurality of modules; and an executing unit that executes each piece of processing determined by calling each module selected.

A method according to another aspect of the present invention is a method for electronic data interchange in which data is transferred from a sender to a receiver. The method includes determining each piece of processing that forms a series of processing to be executed for the data based on at least a transmission method and a data format that are specified by any one of the sender and the receiver or both; selecting a module for each piece of processing determined from among a plurality of modules; and executing each piece of processing determined by calling each module selected.

A computer-readable recording medium according to still another aspect of the present invention stores a computer program that causes a computer to execute the above method.

A computer-readable recording medium according to still another aspect of the present invention stores a computer program that causes a computer to execute determining each piece of processing that forms a series of processing to be executed based on predetermined settings; selecting a module for each piece of processing determined from among a plurality of modules; and executing each piece of processing determined by calling each module selected.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an explanatory diagram of the outline of processing of an electronic data interchange apparatus according to the present invention;

FIG. 2 is a functional block diagram of the configuration of the electronic data interchange apparatus;

FIG. 3 is an explanatory diagram of an example of use condition information;

FIG. 4 is an explanatory diagram of an example of reception template information;

FIG. 5 is an explanatory diagram of an example of transmission template information;

FIG. 6 is an explanatory diagram of an example of a broadcast destination master;

FIG. 7 is an explanatory diagram of an example of a conversion master;

FIG. 8 is a flowchart of the processing of the electronic data interchange apparatus;

FIG. 9 is a flowchart of the processing of transmission template application processing shown in FIG. 8,

FIG. 10 is an explanatory diagram of the operation when data is transmitted from company A to companies X, Y, and Z;

FIG. 11 is an explanatory diagram of the operation when data is transmitted from company B to company W; and

FIG. 12 is a functional block diagram of a computer that executes an electronic data interchange program according to the present invention.

### DETAILED DESCRIPTION

Exemplary embodiments according to the present invention will be explained below in detail with reference to the accompanying drawings.

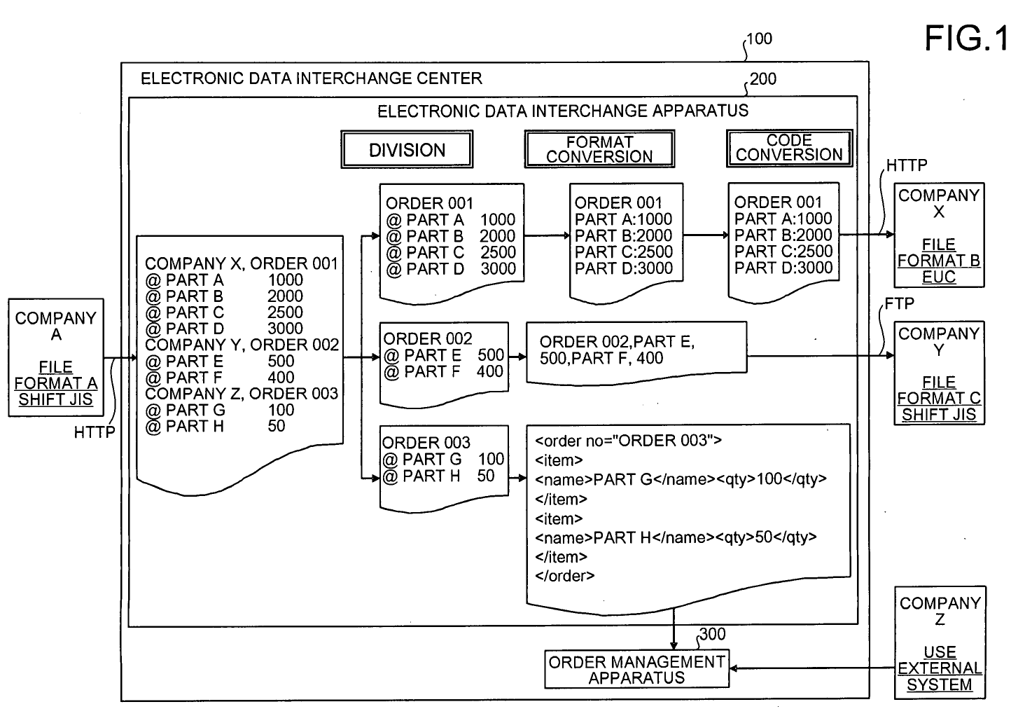

FIG. 1 is an explanatory diagram of the outline of the processing of an electronic data interchange apparatus 200 according to the present invention. The electronic data interchange apparatus 200 is arranged in an electronic data interchange center 100. The electronic data interchange center 100 is a facility operated by a user who provides the electronic data interchange service to other companies, and an order management apparatus 300 that provides an acceptance and placement of order management service is also arranged in the electronic data interchange center 100.

FIG. 1 depicts a case in which data is transmitted from company A to companies X, Y, and Z via the electronic data interchange center 100. The format in which the company A transmits the data to the electronic data interchange center 100 is a file format A, and the character code is shift JIS. The file format A can contain a plurality of data, and the data transmitted from the company A to the electronic data interchange apparatus 200 in the electronic data interchange center 100 in FIG. 1 includes data for the companies X, Y, and Z.

Upon reception of data from the company A, the electronic data interchange apparatus 200 divides it into data for each receiver. The electronic data interchange apparatus 200 then converts the divided respective data to a format and a character code desired by the receiver, and transmits the data by a method desired by the receiver. Specifically, since the company X requests a file format B as the data format, the electronic data interchange apparatus 200 converts the data to the file format B. Since the company X requests EUC as the character code, the electronic data interchange apparatus 200 converts the data to the EUC. Furthermore, since the company X requests HyperText Transfer Protocol (HTTP) as the transmission method, the electronic data interchange apparatus 200 transmits the data in HTTP.

Likewise, the electronic data interchange apparatus 200 performs processing of data for the company Y. Since the company Y requests a file format C as the data format, the electronic data interchange apparatus 200 converts the data to the file format C. As for the character code, since both the company A and the company Y employ shift JIS, no conversion is required. Since the company Y requests File Transfer Protocol (FTP) as the transmission method, the electronic data interchange apparatus 200 transmits the data in FTP.

Since the company Z does not have its own order management system, the company Z uses the order management service provided by the order management apparatus 300. Therefore, the data for the company Z is converted to a format for registering the data in the order management apparatus 300, and sent to the apparatus. The company Z accesses the order management apparatus 300 by using a WEB browser or the like, to refer to or update the order information.

The electronic data interchange apparatus 200 processes the accepted data according to the receiver, and transmits the data with a method corresponding to the receiver. Therefore, as the number of senders and receivers increases, the processing pattern increases.

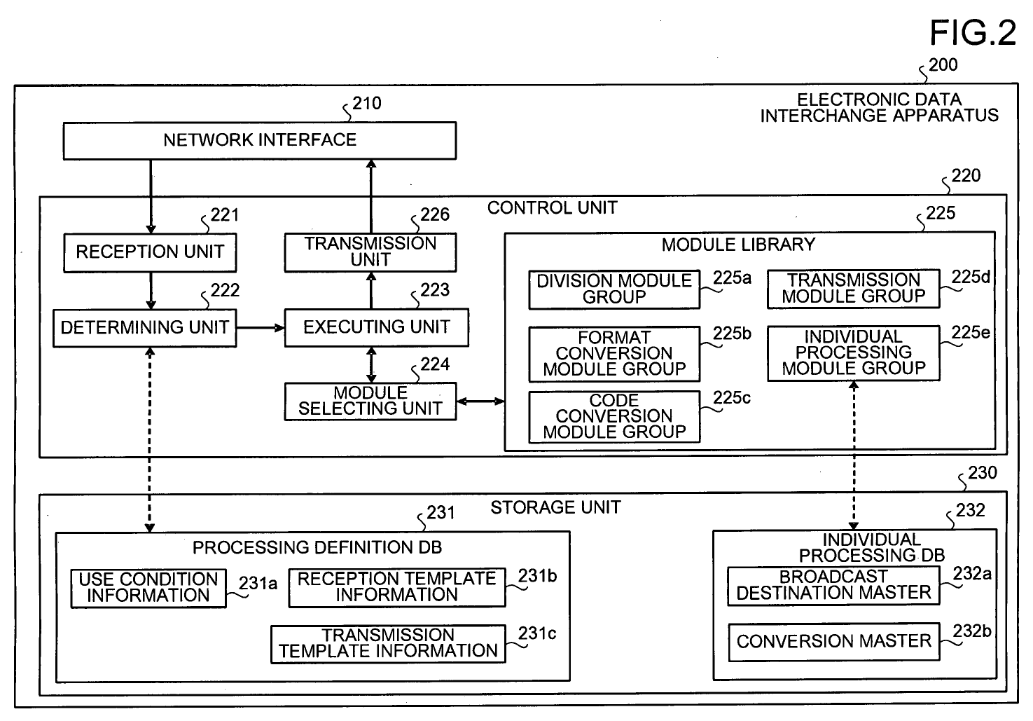

FIG. 2 is a functional block diagram of the configuration of the electronic data interchange apparatus 200. As shown in FIG. 2, the electronic data interchange apparatus 200 includes a network interface 210, a controller 220, and a storage unit 230.

The network interface 210 is an interface for exchanging data with other information processors via a network. The controller 220 controls the whole electronic data interchange apparatus 200, and includes a reception unit 221, a determining unit 222, an executing unit 223, a module selecting unit 224, a module library 225, and a transmission unit 226.

The reception unit 221 receives various data and requests via the network interface 210. The reception unit 221 also identifies a sender by using an Internet Protocol (IP) address, authentication information, and the like of the sender. The determining unit 222 refers to a processing definition DB 231 to determine the processing for the data received by the reception unit 221. For example, when transmitting the received data to a user, the determining unit 222 determines to perform format conversion of the data first, followed by code conversion.

The executing unit 223 executes the processing determined by the determining unit 222. The module selecting unit 224 selects a module required for the executing unit 223 to execute the respective processing from the module library 225. The module library 225 is an aggregate of modules, respectively corresponding to the respective processing for the data, and includes a division module group 225a, a format conversion module group 225b, a code conversion module group 225c, a transmission module group 225d, and an individual processing module group 225e.

The division module group 225a is an aggregate of modules for dividing the received data to data for each receiver. The format conversion module group 225b is an aggregate of modules for performing format conversion of the data. The code conversion module group 225c is an aggregate of modules for performing character code conversion of the data. The transmission module group 225d is an aggregate of modules for transmitting the data in a predetermined method. The individual processing module group 225e is an aggregate of modules for executing the other processing, which are not classified with the above module groups.

The method of executing the respective processing by the executing unit 223 will be explained. The modules included in the module library 225 have a common interface for each module group. For example, in the modules included in the code conversion module group 225c, conversion processing is executed by calling processing referred to as “convert”. Only the module selecting unit 224 recognizes which module corresponds to which processing.

In other words, the executing unit 223 conveys the conversion pattern to the module selecting unit 224, when the character code is converted from shift JIS to EUC, or from shift JIS to UTF8, and the intended processing can be executed only by calling the processing “convert” in the module selected by the module selecting unit 224. By having such a configuration, even when it becomes necessary to correspond to a new character code, correspondence thereto becomes possible only by newly creating a module having a predetermined interface and selecting the module according to need by the module selecting unit 224, without modifying the executing unit 223.

The code conversion module has been explained, but extension is easily possible for other types of modules. When the processing performed by the executing unit 223 and the module selecting unit 224 is configured, existing programming technique can be applied.

Returning to the explanation with reference to FIG. 2, the transmission unit 226 transmits the data processed by the executing unit 223 to the receiver via the network interface 210.

The storage unit 230 stores various types of information, and includes the processing definition DB 231 and an individual processing DB 232. The processing definition DB 231 stores the information for the determining unit 222 to determine the processing, and stores use condition information 231a, reception template information 231b, and transmission template information 231c.

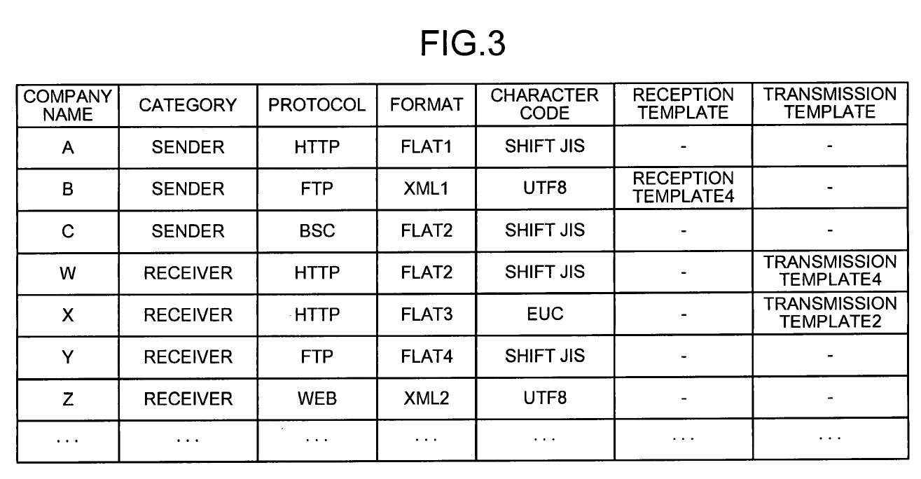

The use condition information 231a holds conditions for the sender users and the receiver users to use the electronic data interchange apparatus 200. Specifically, the use condition information 231a holds the data transmission methods, data format, and character codes of the sender users and the receiver users. FIG. 3 is an explanatory diagram of an example of the use condition information 231a.

As shown in FIG. 3, the use condition information 231a has data items of company name, category, protocol, format, character code, reception template, and transmission template. The item of company name represents an identification name of the user corresponding to the data. The item of category represents whether the user corresponding to the data is a sender of an order or a receiver of the order. The items of protocol, format, and character code respectively represent the data transmission method, data format, and character code.

The items of the reception template and the transmission template respectively represent which template is to be used at the time of receiving and transmitting the data. The template specifies the type and order of the processing for the data. The items of the reception template and the transmission template need not necessarily to be set, and in this case, a template for executing the standard processing is selected, based on other pieces of information, by the determining unit 222.

For example, the data on the first line indicates that the data is for the company A, which is the sender of an order, the company A uses HTTP for data transmission, the data is in FLAT1 format, and the character code is shift JIS. The data on the second line indicates that the data is for company B, which is the sender of an order, the company B uses FTP for data transmission, the data is in XML1 format, and the character code is UTF8, and hence, when the data is received. from the company A, it is necessary to process the data according to a reception template 4.

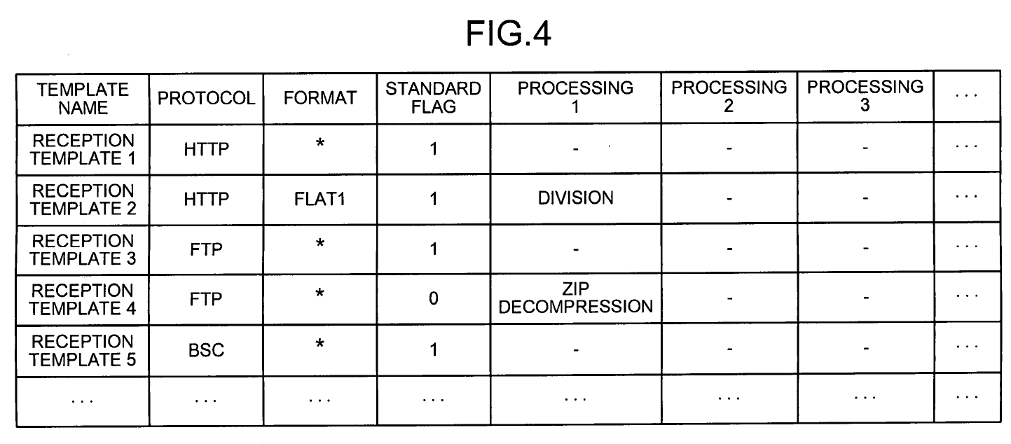

The reception template information 231b holds the type and order of the processing to be executed at the time of receiving data. FIG. 4 is a explanatory diagram of an example of the reception template information 231b. As shown in FIG. 4, the reception template information 231b has data items of template name, protocol, format, and standard flag. The reception template information 231b also has a variable number of data items representing the processing.

The item of template name represents an identification name of the template. The items of protocol and format respectively represent the data transmission method and data format. The item of standard flag represents whether the template is a standard template including a combination of the protocol and the format. The standard flag takes a value “1” only for the standard template, among the templates having the same combination of protocol and format, and takes a value “0” for the other templates. The item of processing holds the identification names of the processing to be executed, in order of execution.

The items of protocol, format, and standard flag become the basis for the determining unit 222 to select the reception template corresponding to the received data. When there is no designation of the reception template in the use condition of the sender obtained from the use condition information 231a, the determining unit 222 selects the information in which the protocol and the format match each other and the standard flag is “1”.

For example, when data in the FLAT1 format is received by the HTTP protocol, the data on the second line in FIG. 4 in which the item of protocol is “HTTP”, the item of format is “FLAT1”, and the item of standard flag is “1” is selected, and it is determined that “division” is necessary as the processing for the data.

The item of format can take “*” as a value. When there is no template that matches the protocol and the format of the received data from the sender in the reception template information 231b, a reception template whose protocol matches the protocol of the received data, whose format is “*”, and whose standard flag is “1” is selected.

For example, when data in the XML1 format is received by the HTTP protocol, since there is no data in which the protocol is “HTTP”, the format is “XML1”, and the standard flag is “1”, the data on the first line in FIG. 4, in which the protocol is “HTTP”, the format is “*”, and the standard flag is “1” is selected, and it is determined that there is no processing required for the data.

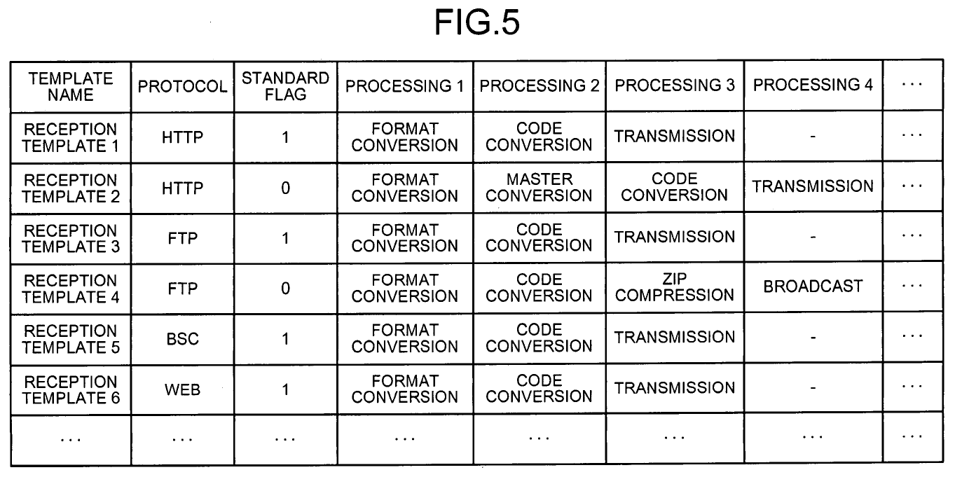

The transmission template information 231c holds the type and order of the processing to be executed at the time of transmitting the data. FIG. 5 is an explanatory diagram of an example of the transmission template information 231c. As shown in FIG. 5, the transmission template information 231c includes data items of template name, protocol, and standard flag. The transmission template information 231c also includes a variable number of data items representing the processing.

The item of template name represents an identification name of the template. The item of protocol represents the data transmission method, and the item of standard flag represents whether the template is a standard template of the protocol. The standard flag takes a value “1” only for the standard template, among the templates having the same protocol, and takes a value “0” for the other templates. The item of the processing holds the identification name of the processing to be executed.

The items of protocol and standard flag become the basis for the determining unit 222 to select the transmission template corresponding to the receiver. When there is no designation of the transmission template in the use condition of the receiver obtained from the use condition information 231a, the determining unit 222 selects the transmission template whose protocol matches the protocol of the receiver and whose standard flag is “1”.

For example, when the transmission method to the receiver is the HTTP protocol, the data on the first line in FIG. 5 in which the protocol is “HTTP”, and the standard flag is “1” is selected, and it is determined that “format conversion”, “code conversion”, and “transmission” are required as the processing for the data.

In the electronic data interchange apparatus 200 according to this embodiment, instead of defining individually the whole processing for each of all combinations of a sender and a receiver, each standard component of the processing is defined in a common template. By using the template, definition of the processing can be commonly used, and even when the number of users increases, the number of steps for registering and managing the processing can be reduced.

The individual processing DB 232 stores information used by a module belonging to the individual processing module group 225e at the time of executing the processing, and stores a broadcast destination master 232a and a conversion master 232b.

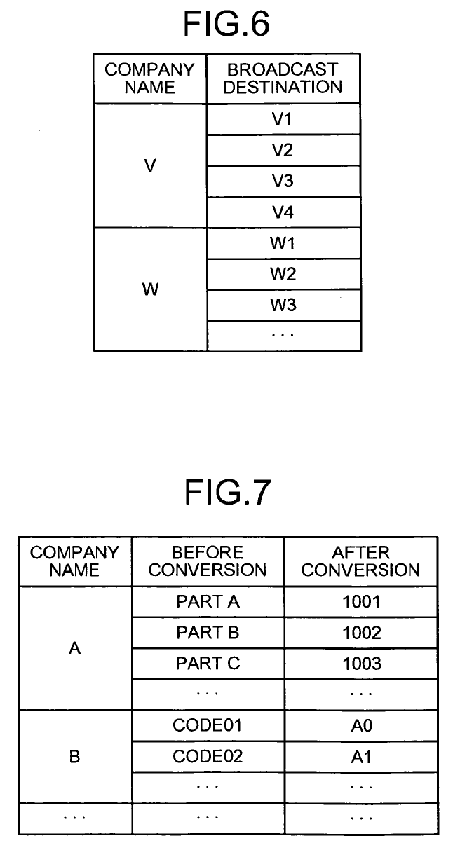

The broadcast destination master 232a holds broadcast destination information used by a module that performs broadcast. The broadcast is a function for performing transmission to a plurality of users, by replacing the receiver, when a specific user is designated as the receiver. FIG. 6 is an explanatory diagram of an example of the broadcast destination master 232a. As shown in FIG. 6, the broadcast destination master 232a includes data items of company name and broadcast destination.

When a user registered in the item of company name is designated as the receiver, the broadcast module performs transmission to users registered in the broadcast destination. For example, when company W is designated as the receiver, data is transmitted to three companies of company W1, company W2, and company W3.

The conversion master 232b holds conversion rules used by modules that perform master conversion processing. The master conversion processing is a function for converting data based on a predetermined conversion rule. FIG. 7 is an explanatory diagram of an example of the conversion master 232b. As shown in FIG. 7, the conversion master 232b includes data items of company name, before conversion, and after conversion. The item of company name represents an identification name of the receiver, for which data conversion is required. The items of before conversion and after conversion respectively represent a combination of a character string requiring conversion and a character string replacing the character string.

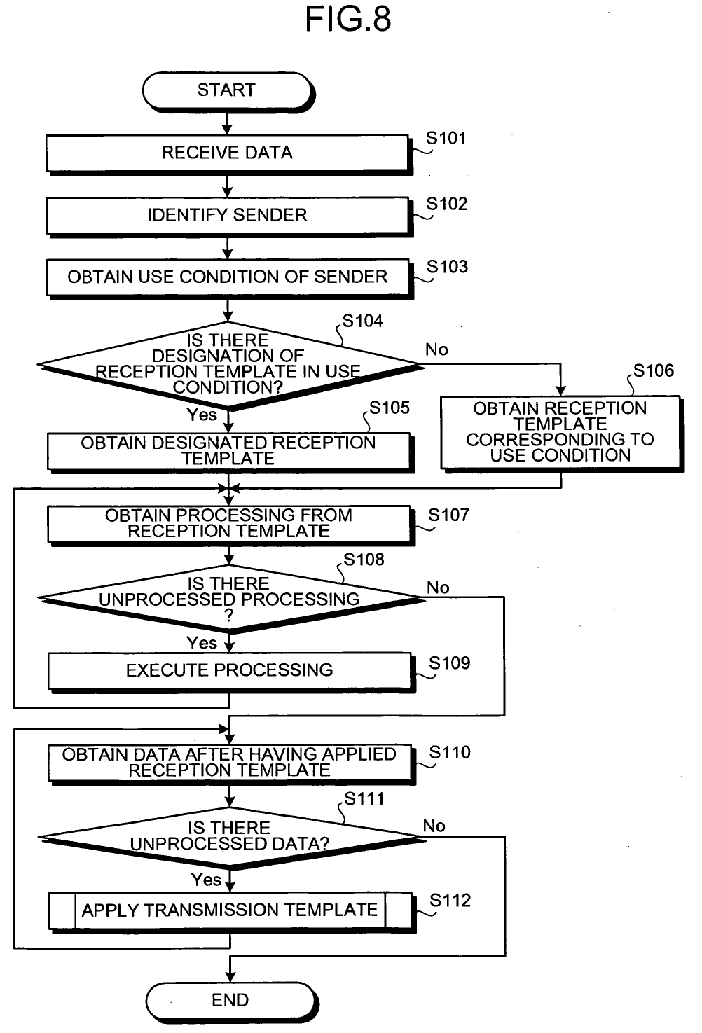

FIG. 8 is a flowchart of the processing of the electronic data interchange apparatus 200 shown in FIG. 2. As shown in FIG. 8, the reception unit 221 first receives the data (step S101), to identify the sender of the data (step S102).

The determining unit 222 having obtained the information of the sender from the reception unit 221 obtains the use condition of the sender from the use condition information 231a (step S103). When there is a designation of the reception template in the use condition (Yes at step S104), the designated reception template is obtained from the reception template information 231b (step S105). When there is no designation of the reception template in the use condition (No at step S104), the standard reception template corresponding to the transmission method and the data format of the sender is obtained from the reception template information 231b (step S106).

Subsequently, the executing unit 223 obtains one processing at the top, which has not been executed, from the reception template (step S107). When the processing can be obtained (Yes at step S108), the processing is executed (step S109), and control returns to step S107 to obtain the next processing. When the processing cannot be obtained (No at step S108), processing of the data based on the reception template is finished, to proceed to step S110. When division is included in the processing, the data is divided into a plurality of numbers as a result of completion of processing of the data based on the reception template.

When data processing based on the reception template has finished, the determining unit 222 obtains one unprocessed data after having been processed based on the reception template (step S110). When the unprocessed data can be obtained (Yes at step S111), the transmission template application processing described later is performed (step S112). When there is no unprocessed data (No at step S111), the processing is finished.

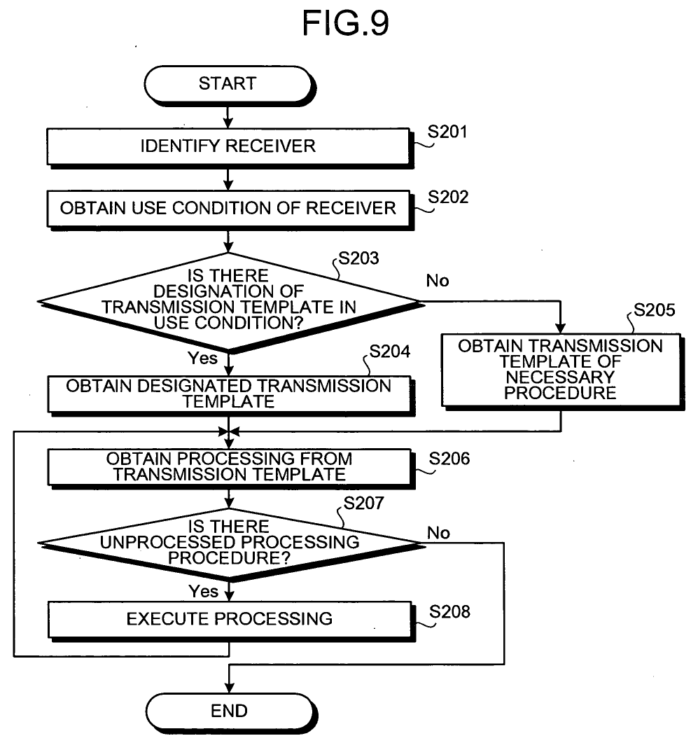

FIG. 9 is a flowchart of the transmission template application processing shown in FIG. 8. At first, the determining unit 222 identifies the receiver of data (step S201), and obtains the use condition of the receiver from the use condition information 231a (step S202). When there is a designation of the transmission template in the use condition (Yes at step S203), the designated transmission template is obtained from the transmission template information 231c (step S204). When there is no designation of the transmission template in the use condition (No at step S203), a standard transmission template corresponding to the transmission method of the receiver is obtained from the transmission template information 231c (step S205).

Subsequently, the executing unit 223 obtains one processing at the top, which has not been executed, from the transmission template (step S206). When the processing can be obtained (Yes at step S207), the processing is executed (step S208), and control returns to step S206 to obtain the next processing. When the processing cannot be obtained (No at step S207), the transmission template application processing is finished.

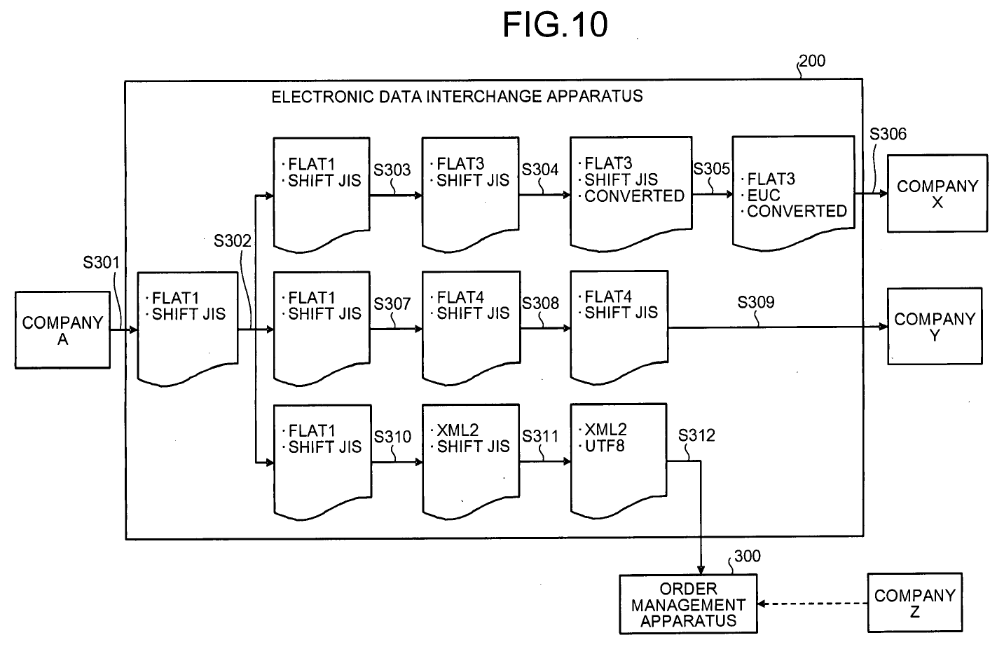

The operation of the electronic data interchange apparatus 200 according to the embodiment will be explained by way of one example. It is assumed here that the contents of the various types of information stored in the storage unit 230 are as shown in FIGS. 3 to 7. FIG. 10 is an explanatory diagram of the operation when data is to be transmitted from the company A to the companies X, Y, and Z.

When the reception unit 221 receives the data from the company A, the determining unit 222 obtains the use condition of the company A from the use condition information 231a. Accordingly, the data transmission method of the company A is found as HTTP, the data format is FLAT1, and the character code is shift JIS. Subsequently, the determining unit 222 obtains the reception template corresponding to the use condition from the reception template information 231b. In this case, the data on the second line in FIG. 4 whose transmission method and the data format match those of the received data is obtained (step S301).

When the reception template is obtained, the executing unit 223 executes the processing based on the reception template. Since there is the processing of “division” in the obtained reception template, the executing unit 223 instructs the module selecting unit 224 to select a module for dividing the data in the FLAT1 format. The dividing processing is executed by the selected module, and the data is divided into three for the companies X, Y, and Z (step S302).

When application of the reception template has finished, application of the transmission template is performed for respective data. Here, the data for the company X is processed first. When the use condition of the company X is obtained from the use condition information 231a, the data transmission method of the company X is found as HTTP, the data format is FLAT3, and the character code is EUC. Furthermore, it is necessary to use a transmission template 2 as the transmission template.

In the transmission template, it is defined that it is necessary to execute the processing of “format conversion”, “master conversion”, “code conversion”, and “transmission” in this order, and the executing unit 223 executes the processing based on this definition. For the “format conversion”, a module for converting the data format “FLAT1 ” of the company A to the data format “FLAT3 ” of the company X is selected by the module selecting unit 224, and the conversion processing of the selected module is called, to execute the conversion (step S303).

For the “master conversion”, an individual processing module for executing the master conversion processing is selected by the module selecting unit 224, and the conversion processing of the selected module is called, to execute the conversion (step S304). For the “code conversion”, a module for converting the character code “shift JIS” of the company A to the character code “EUC” of the company X is selected by the module selecting unit 224, and the conversion processing of the selected module is called, to execute the conversion (step S305).

As the transmission method of the company X, a module for transmitting the data by HTTP is selected by the module selecting unit 224, and the transmission processing of the selected module is called to transmit the data to the company X (step S306).

Subsequently, the data for the company Y is processed. When the use condition of the company Y is obtained from the use condition information 231a, the data transmission method of the company Y is found as FTP, the data format is FLAT4, and the character code is shift JIS. Furthermore, there is no designation of the transmission template. In this case, since the transmission template is not designated, a transmission template 1, which is the standard transmission template of HTTP, is employed.

In the transmission template 1, it is defined that it is necessary to execute the processing of “format conversion”, “code conversion”, and “transmission” in this order, and the executing unit 223 executes the processing based on this definition. For the “format conversion”, a module for converting the data format “FLAT1” of the company A to the data format “FLAT4” of the company Y is selected by the module selecting unit 224, and the conversion processing of the selected module is called, to execute the conversion (step S307).

For the “code conversion”, since the character code of the company A and the character code of the company Y are both shift JIS, no particular processing is performed (step S308). As the transmission method of the company Y, a module for transmitting the data by FTP is selected by the module selecting unit 224, and the transmission processing of the selected module is called to transmit the data to the company Y (step S309).

Lastly, the data for the company Z is processed. When the use condition of the company Z is obtained from the use condition information 231a, the data transmission method of the company Z is found as WEB, the data format is XML2, and the character code is UTF8. Furthermore, there is no designation of the transmission template. In this case, since the transmission template is not designated, a transmission template 6, which is the standard transmission template of WEB, is employed.

In the transmission template, it is defined that it is necessary to execute the processing of “format conversion”, “code conversion”, and “transmission” in this order, and the executing unit 223 executes the processing based on this definition. For the “format conversion”, a module for converting the data format “FLAT1 ” of the company A to the data format “XML2” of the company Z is selected by the module selecting unit 224, and the conversion processing of the selected module is called to execute the conversion (step S310).

For the “code conversion”, a module for converting shift JIS, as the character code of the company A, to UTF8, as the character code of the company Z, is selected by the module selecting unit 224, and the conversion processing of the selected module is called to execute the conversion (step S311). A module for transmitting the data by the WEB, as the transmission method of the company Z, is selected by the module selecting unit 224, and the transmission processing of the selected module is called to transmit the data (step S312). The WEB is a method of sending the data to the order management apparatus 300, and hence, the data is not transmitted directly to the company Z. The company Z uses a WEB browser or the like to access the order management apparatus 300, to refer to or update the information.

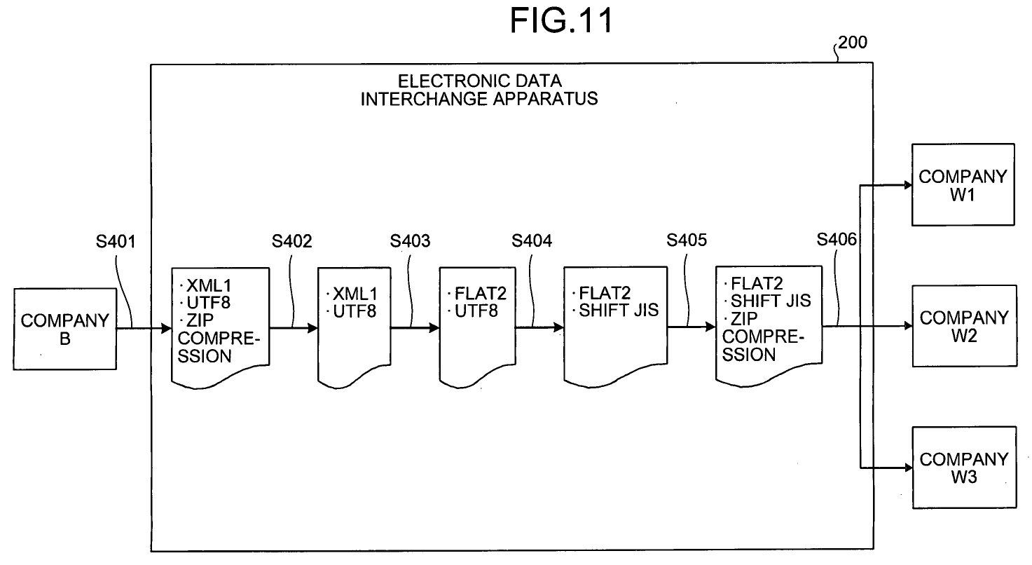

The operation of the electronic data interchange apparatus 200 according to this embodiment will be explained by way of another example. FIG. 11 is an explanatory diagram of transmitting data from the company B to the company W.

When the reception unit 221 has received the data from the company B, the determining unit 222 obtains the use condition of the company B from the use condition information 231a. Accordingly, the data transmission method of the company B is found as FTP, the data format is XML1, and the character code is UTF8. Furthermore, it is found to be necessary to use the reception template 4 as the reception template (step S401).

Since there is a processing of “ZIP decompression” in the reception template 4, the executing unit 223 instructs the module selecting unit 224 to select an individual module for decompressing a compressed file in the ZIP format. The executing unit 223 then executes the decompression processing of the selected module, to decompress the data (step S402).

When application of the reception template has finished, application of the transmission template is performed. Referring to the decompressed data, it is turned out that the data is for the company W. Therefore, the determining unit 222 obtains the information of the company W from the use condition information 231a. Accordingly, the data transmission method of the company W is found as HTTP, the data format is FLAT2, and the character code is shift JIS. Furthermore, it is found that to be necessary to use a transmission template 4 as the transmission template.

In the transmission template 4, it is defined that it is necessary to execute the processing of “format conversion”, “code conversion”, “ZIP decompression”, and “broadcast” in this order, and the executing unit 223 executes the processing based on this definition. For the “format conversion”, a module for converting the data format “XML1” of the company B to the data format “FLAT2” of the company W is selected by the module selecting unit 224, and the conversion processing of the selected module is called, to execute the conversion (step S403).

For the “code conversion”, a module for converting the character code “UTF8” of the company B to the character code “shift JIS” of the company W is selected by the module selecting unit 224, and the conversion processing of the selected module is called to execute the conversion (step S404). For the “ZIP decompression”, an individual processing module for executing the decompression processing of the ZIP format is selected by the module selecting unit 224, and the decompression processing of the selected module is called to execute decompression of data (step S405).

As the transmission method of the company W, a module for broadcasting the data by HTTP is selected by the module selecting unit 224, and the transmission processing of the selected module is called to broadcast the data (step S406). The selected module does not actually transmit the data to the company W but refers to the broadcast destination master 232a, to transmit the data to companies W1, W2, and W3, which are registered as the broadcast destinations of the company W.

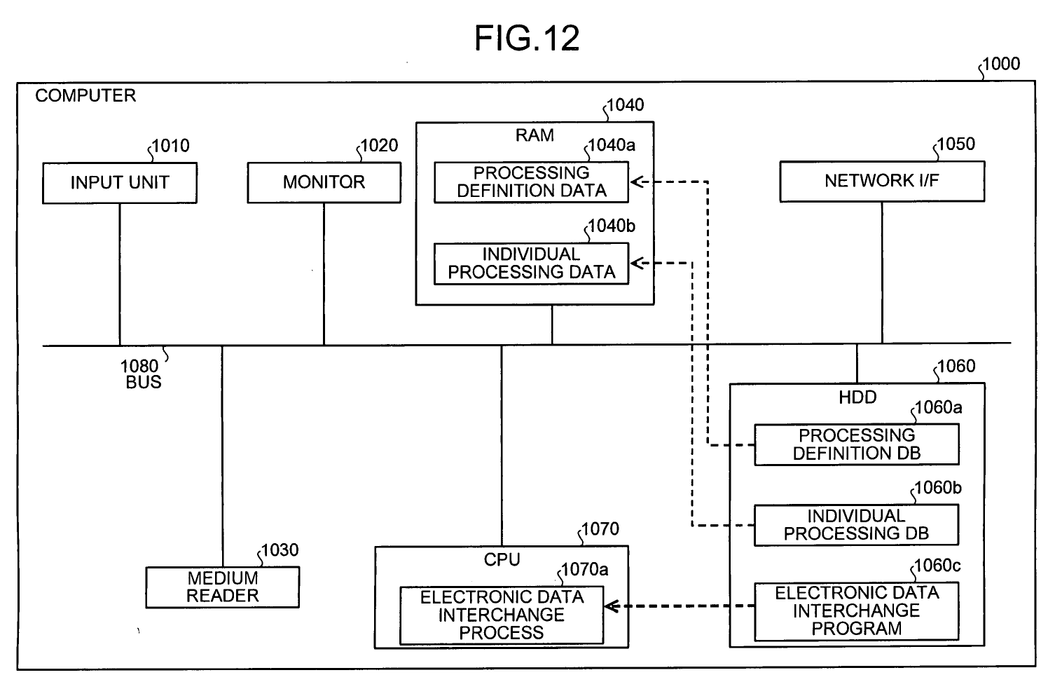

The various types of processing explained in the embodiment can be realized by executing a program prepared in advance by a computer. One example of the computer that executes the program for realizing the electronic data interchange apparatus 200 according to the embodiment will be explained, with reference to FIG. 12.

FIG. 12 is a functional block diagram of a computer that executes the electronic data interchange program. A computer 1000 is configured by connecting an input unit 1010 that accepts input of data from a user, a monitor 1020, a medium reader 1030 that reads a program from a recording medium storing various programs, a random access memory (RAM) 1040 for temporarily storing various types of information, a network interface 1050 for transferring data between the computer and other computers via a network, a hard disk drive (HDD) 1060, and a CPU 1070 via a bus 1080.

As a program for demonstrating the same functions as those of the electronic data interchange apparatus 200, an electronic data interchange program 1060c is stored in the HDD 1060. The CPU 1070 reads the electronic data interchange program 1060c from the HDD 1060 to execute the program. Accordingly, the program functions as an electronic data interchange process 1070a. The electronic data interchange process 1070a corresponds to the controller 220 shown in FIG. 2.

The CPU 1070 reads necessary information from a processing definition DB 1060a and an individual processing DB 1060b in the HDD 1060, stores these in the RAM 1040 as processing definition data 1040a and individual processing data 1040b, and executes various types of data processing based on the processing definition data 1040a and the individual processing data 1040b stored in the RAM 1040. The processing definition DB 1060a and the individual processing DB 1060b respectively correspond to the processing definition DB 231 and the individual processing DB 232 in FIG. 2.

It is not always necessary that the electronic data interchange program 1060c is stored in the HDD 1060, and the program stored in a recording medium such as a CD-ROM can be read and executed by the computer 1000. Furthermore, the program can be stored in another computer (or server) connected to the computer 1000 via a public line, the Internet, the LAN, or the WAN, and the computer 1000 can read out the program from the computer (or server) and execute the program.

In the embodiment, an example in which the electronic data interchange apparatus 200 is installed in the electronic data interchange center 100, and is commonly used by a plurality of users has been explained. However, the electronic data interchange apparatus 200 is also useful when it is used by a particular user.

According to the present invention, processing is determined based on pre-registered setting information, and the determined processing are executed by calling a module, which is formed as a component. Accordingly, it is not necessary to make processing for each combination of a sender and a receiver, and even when the number of combinations of a sender and a receiver increases, efficient handling thereto is possible.

According to the present invention, the configuration of the processing is registered in a template, so that one template is commonly used by a plurality of combinations of a sender and a receiver. Accordingly, it is not necessary to register the processing for each combination of a sender and a receiver, and hence, even when the number of combinations of a sender and a receiver increases, efficient handling thereto is possible.

According to the present invention, a common interface is provided to modules, which are formed as a component for executing the processing, and the module calling side uses the common interface to call the processing. Accordingly, even when a new processing becomes necessary due to an increase in the combination of a sender and a receiver, handling thereto is easily possible only by adding a new module.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores a computer program for electronic data interchange in which data is transferred from a sender to a receiver, wherein the computer program causes a computer to execute:
determining each piece of processing that forms a series of processing to be executed for the data based on at least a transmission method and a data format that are specified by any one of the sender and the receiver or both;
selecting a module for each piece of processing determined from among a plurality of modules; and
executing each piece of processing determined by calling each module selected.

2. The computer-readable recording medium according to claim 1, wherein the determining includes determining each piece of processing by referring to a template in which configuration of the series of processing is registered beforehand.

3. The computer-readable recording medium according to claim 1, wherein the executing includes calling each module based on an interface common to a plurality of modules in a group.

4. An electronic data interchange apparatus for transferring data from a sender to a receiver, comprising:
a determining unit that determines each piece of processing that forms a series of processing to be executed for the data based on at least a transmission method and a data format that are specified by any one of the sender and the receiver or both;
a selecting unit that selects a module for each piece of processing determined from among a plurality of modules; and
an executing unit that executes each piece of processing determined by calling each module selected.

5. The electronic data interchange apparatus according to claim 4, wherein the determining unit determines each piece of processing by referring to a template in which configuration of the series of processing is registered beforehand.

6. The electronic data interchange apparatus according to claim 4, wherein the executing unit executes each piece of processing determined by calling each module based on an interface common to a plurality of modules in a group.

7. A method for electronic data interchange in which data is transferred from a sender to a receiver, comprising:
determining each piece of processing that forms a series of processing to be executed for the data based on at least a transmission method and a data format that are specified by any one of the sender and the receiver or both;
selecting a module for each piece of processing determined from among a plurality of modules; and
executing each piece of processing determined by calling each module selected.

8. The method for electronic data interchange according to claim 7, wherein the determining includes determining each piece of processing by referring to a template in which configuration of the series of processing is registered beforehand.

9. The method for electronic data interchange according to claim 7, wherein the executing includes calling each module based on an interface common to a plurality of modules in a group.

10. A computer-readable recording medium that stores a computer program that causes a computer to execute:
determining each piece of processing that forms a series of processing to be executed based on predetermined settings;
selecting a module for each piece of processing determined from among a plurality of modules; and
executing each piece of processing determined by calling each module selected.
